(19) United States
(12) Patent Application Publication
(10) Pub. No.: US 2026/0178343 A1
(43) Pub. Date: Jun. 25, 2026

(54) DYNAMIC AI MODEL SELECTION AND PRE-LOADING BASED ON DATA TEMPERATURE SCORING AND NEXT PROMPT PREDICTION

(71) Applicant: SK Hynix NAND Product Solutions Corp. (dba Solidigm), Rancho Cordova, CA (US)

(72) Inventors: Caleb MCMILLAN, Forest Grove, OR (US); Rita H. WOUHAYBI, Portland, OR (US); Priyanka MUDGAL, Portland, OR (US)

(21) Appl. No.: 19/000,252

(22) Filed: Dec. 23, 2024

(51) Int. Cl. G06F 9/445; G06F 9/50; G06F 16/951; G06F 40/205

(52) U.S. Cl. CPC G06F 9/445; G06F 9/5027; G06F 16/951; G06F 40/205

(57) ABSTRACT

A system and method are provided for artificial intelligence (AI) model selection and loading. The method includes receiving an input data stream for an AI application and analyzing the stream to determine temperature scores based on topic frequency, importance weightage, and access frequency. The method also includes mapping these temperature scores to relevant expert AI models and predicting the temperature and context of the next prompt using historical data patterns through a sliding window that smooths temporary anomalies. The system dynamically selects AI models based on temperature scores and predicted contexts, then pre-loads these models into a memory hierarchy where higher-temperature models are placed in faster memory. The method processes incoming prompts using these pre-loaded models and outputs responses, improving processing efficiency through predictive model management. The system addresses challenges of managing large-scale AI models by implementing intelligent pre-loading mechanisms that anticipate and prepare for upcoming processing needs.

### BACKGROUND

Artificial Intelligence (AI) models have grown increasingly complex, with state-of-the-art models now exceeding 800 Gigabytes (GB) in memory footprint due to billions of parameters and extensive training datasets. This substantial memory requirement poses significant challenges for systems with limited memory capacity, forcing them to adopt suboptimal solutions. One conventional approach involves partially loading model weights into memory and dynamically swapping portions as needed for specific tasks. Another approach splits a large monolithic model into smaller, domain-specific expert models. For example, rather than maintaining an 800 GB model capable of handling diverse tasks, such as bird species classification, pop culture analysis, and power usage forecasting, systems may utilize multiple smaller (less than 100 GB) expert models, each specialized for a specific domain. However, both approaches suffer from significant performance limitations. The constant loading and unloading of either model portions or complete expert models introduces substantial inefficiencies and processing delays. Traditional systems typically manage this challenge by reactively loading partial weights or expert models based on incoming data patterns. This reactive approach results in unpredictable performance that varies significantly depending on the sequence and nature of incoming data requests. The technical problems created by these conventional approaches include inconsistent response times, inefficient memory utilization, and degraded application performance. These issues are particularly acute in applications requiring real-time or near-real-time responses, where the overhead of model switching or weight loading can introduce unacceptable latency.

### SUMMARY

Accordingly, there is a need for systems and methods that address at least some of the problems described above. Embodiments of the present disclosure provide systems and methods for optimizing artificial intelligence (AI) model selection and loading through dynamic temperature scoring and predictive pre-loading. The disclosed technology addresses critical technical challenges in managing large-scale AI models by implementing an intelligent pre-loading system that operates in parallel with AI applications utilizing either partially loaded large models or distributed expert models. The system performs technical functions, such as data temperature classification using learned features from historical data points, next prompt prediction based on current and historical data analysis, and dynamic model loading guided by predicted prompts and temperature ratings.

The disclosed technology provides concrete technical improvements over conventional systems by significantly reducing response latency and optimizing memory utilization through predictive model management. Unlike traditional reactive approaches that load models only after receiving a prompt, the present system employs sophisticated machine learning techniques to anticipate future prompts and pre-load relevant models into a multi-tiered memory hierarchy. This proactive approach, combined with dynamic temperature scoring that considers factors, such as topic frequency, importance weightage, and access patterns, represents a novel technical solution that cannot be performed by human mental processes due to the complexity of real-time data analysis and the scale of model management required.

The technology described herein addresses particular technical problems in AI model management through specific technical solutions. For example, according to some embodiments, the system tackles the challenge of unpredictable response times in large-scale AI applications by implementing a sophisticated Bayesian network for prompt prediction, coupled with a multi-tiered memory management system that optimizes model placement based on temperature scores. Some embodiments further incorporate real-time social media crawling and news source monitoring to dynamically adjust topic importance, creating a responsive system that adapts to emerging trends. These technical features, combined with the implementation of feedback loops for continuous optimization and the use of deep learning-based importance weightage calculations, constitute significantly more than conventional approaches and demonstrate a clear practical application in improving AI system performance.

In one aspect, a computer-implemented method is provided for applying artificial intelligence (AI) models. The method is implemented at a computing system having one or more processors and a memory hierarchy. The method includes obtaining an input data stream including a plurality of historical data points, analyzing the input data stream to determine a temperature score for each of the plurality of historical data points, generating temperature scores of expert AI models associated with the input data stream based on the temperature scores of the plurality of historical data points, predicting a temperature and context of a next prompt in the input data stream based on the plurality of historical data points, selecting one or more AI models from the expert AI models based on the temperature scores of the expert AI models and the temperature and context of the next prompt, and pre-loading the selected one or more AI models into the memory hierarchy for processing the next prompt.

In one aspect, a method is provided for optimizing artificial intelligence (AI) model selection and loading in a computing system. The method includes receiving an input data stream for an AI application. The method also includes analyzing the input data stream to determine a temperature score for each data point. The temperature score is calculated based on: (a) frequency of occurrence of topics within the data point, (b) importance weightage of the topics, and (c) frequency of access of the topics. The method also includes mapping the temperature score of each data point to relevant expert AI models. The method also includes predicting a temperature and context of a next prompt in the input data stream based on patterns in historical data points. The prediction utilizes a sliding window to smooth out temporary spikes or anomalies. The method also includes dynamically selecting one or more AI models based on the temperature scores of the expert AI models and the predicted temperature and context of the next prompt. The method also includes pre-loading the selected one or more AI models into a memory hierarchy of the computing system. The models with higher temperature scores are loaded into faster memory. The method also includes receiving the next prompt in the input data stream. The method also includes processing the next prompt using the pre-loaded AI models. The method also includes outputting a response to the next prompt.

In some embodiments, predicting the temperature and context of the next prompt includes using one or more deep learning-based techniques to model temporal patterns and conditional probabilities based on historical prompt sequences.

In some embodiments, the method also includes crawling social media and public news sources to identify rapidly gaining topics for incorporation into the next prompt prediction. The credibility and relevance of the identified topics are determined based on their popularity and frequency of occurrence across multiple sources.

In some embodiments, pre-loading the selected AI models includes ranking available expert models by temperature. The method also includes loading very high temperature models into the fastest available memory. The method also includes loading lower temperature models into progressively slower memory tiers. The method also includes implementing a caching mechanism for frequently used model components. This allows partial model loading to improve response time for hybrid queries spanning multiple expert domains.

In some embodiments, the method also includes predicting prompts beyond the next prompt to create a prediction tree for determining cumulative probabilities of topic occurrence. The cumulative probabilities are used to anticipate model hotness over an extended time period to optimize model swapping frequency.

In some embodiments, processing the next prompt includes utilizing a less accurate, already-loaded model for non-critical or cold topics to avoid loading and unloading a specialized cold model.

In some embodiments, the temperature score is calculated using the equation:

$$data temperature = frequency of occurrence of topics within data points + importance weightage of thetopics + frequency of access of the topics .$$

In some embodiments, the method also includes updating the temperature classification of expert AI models based on changes in the data stream temperature over time. A decay function is applied to historical data points in the temperature score calculation. More recent data points are weighted more heavily than older data points to reflect current trends.

In some embodiments, analyzing the input data stream includes using natural language processing techniques to extract and classify topics from unstructured text data. This enables temperature score calculation for diverse input formats.

In some embodiments, the method also includes implementing a feedback loop. The accuracy and relevance of AI model responses are used to dynamically adjust the temperature scores of both the input data and the corresponding expert models.

In some embodiments, the importance weightage is calculated using one or more deep learning-based techniques. The importance weightage is continuously updated based on the context of user queries and internal usage patterns for answering queries.

In some embodiments, the temperature score for each data point is further based on whether the data point originates from an automated system query or a human-generated query.

In some embodiments, the method also includes generating a heat map visualization of topic temperatures over time. The heat map is used to identify trends and patterns in data stream content for long-term model optimization.

In some embodiments, the memory hierarchy comprises at least three tiers of memory with different access speeds. The pre-loading step distributes AI models across the tiers based on their respective temperature scores.

In another aspect, a computing system includes one or more processors, memory, and one or more programs stored in the memory. The programs are configured for execution by the one or more processors. The programs include instructions for performing any of the methods described herein.

In another aspect, a non-transitory computer readable storage medium stores one or more programs configured for execution by one or more processors of a computing system. The programs include instructions for performing any of the methods described herein.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

FIG. 1 is a block diagram of an example system for optimizing AI model selection and loading, according to some embodiments.

FIG. 2A is a schematic diagram of an example data temperature classification module, according to some embodiments.

FIG. 2B is a schematic diagram of an example next prompt prediction module, according to some embodiments.

FIG. 2C a schematic diagram of an example dynamic model loader, according to some embodiments.

FIG. 2D is a schematic diagram of an example memory hierarchy for model storage, in accordance with some embodiments.

FIG. 2E illustrates an example prediction tree showing probability-based topic transitions, according to some embodiments.

FIG. 3 shows a block diagram of an example computing device for optimizing artificial intelligence (AI) model selection and loading, according to some embodiments.

FIG. 4 is a flowchart of an example method for optimizing AI model selection and loading, according to some embodiments.

FIG. 5 is a flowchart of another example method for AI model selection and loading, according to some embodiments.

Like reference numerals refer to corresponding parts throughout the drawings.

### DESCRIPTION OF IMPLEMENTATIONS

Reference will now be made to various implementations, examples of which are illustrated in the accompanying drawings. In the following detailed description, numerous specific details are set forth in order to provide a thorough understanding of the invention and the described implementations. However, the invention may be practiced without these specific details. In other instances, well-known methods, procedures, components, and circuits have not been described in detail so as not to unnecessarily obscure aspects of the implementations.

This patent application includes examples with specific numerical values to illustrate certain embodiments of the invention. These values are provided solely for illustrative purposes and are neither exhaustive nor restrictive. Their purpose is to aid in understanding the invention and its potential applications. Accordingly, the scope of the invention is not confined to the disclosed numerical values but extends to variations, modifications, interpolations, derivations, and equivalents that would be reasonable to those skilled in the art.

The optimization of artificial intelligence (AI) model selection and loading presents significant technical challenges in modern computing systems, particularly as AI applications increasingly require access to multiple specialized models for different types of queries. Traditional approaches to model management rely on reactive loading strategies, where models are loaded into memory only after a specific need is identified, resulting in substantial processing delays and inefficient resource utilization. These challenges are compounded by memory constraints, as large AI models often exceed hundreds of gigabytes in size and cannot be simultaneously loaded into memory on most systems. The implementation of effective model management strategies is crucial for minimizing response latency, optimizing resource allocation, and maintaining system performance across diverse query types. Disclosed embodiments enable optimization of AI model selection and loading. Systems, methods and devices implementing the techniques in accordance with some embodiments are described below.

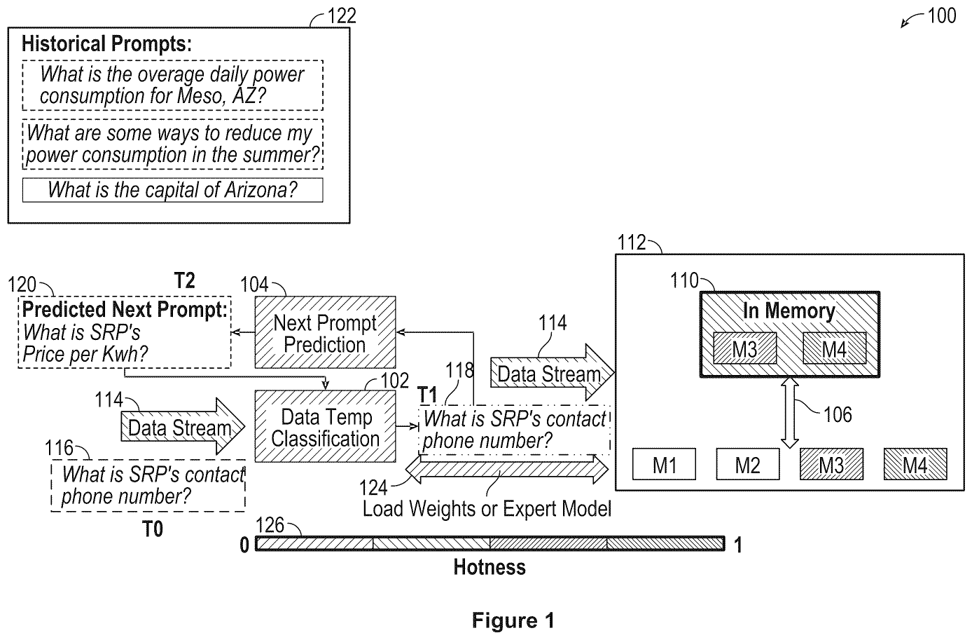

FIG. 1 is a block diagram of an example system 100 for optimizing AI model selection and loading, according to some embodiments. The system 100 includes a data temperature classification module 102 that receives an input data stream 114 and analyzes it to determine temperature scores for machine learning models. The module 102 communicates with a next prompt prediction module 104, which predicts upcoming prompts based on historical patterns. A dynamic model loader 106 receives input from both modules to manage model loading. For illustration, suppose various expert AI models M1, M2, M3, and M4 correspond to an AI application 112. The models are classified by temperature (hot, warm, cold). Further suppose that the system receives an input prompt 116 (“What is SRP's phone number”) at T0. At T1, this prompt is classified as warm 118 based on similarity scoring. At T2, the system predicts that the next prompt 120 will contain hot topics related to power consumption. Historical prompts 122 can be used for next prompt prediction 104. The next prompt prediction and data temperature classification (sometimes referred to as model classification) enable preemptive loading (106) of relevant models M3 and M4 into memory 110. The term “temperature” can be used to refer to both data and AI models. For example, “hot” data refers to data that contains topics that frequently occur in the data stream and/or topics that are explicitly identified as important by the AI application. A “hot” model refers to an AI model with expertise covering one or more “hot” topics. Conversely, “cold” data contains no “hot” topics and utilizes a “cold” AI model. Cold models can include models that have not been loaded into memory based on previous usage patterns.

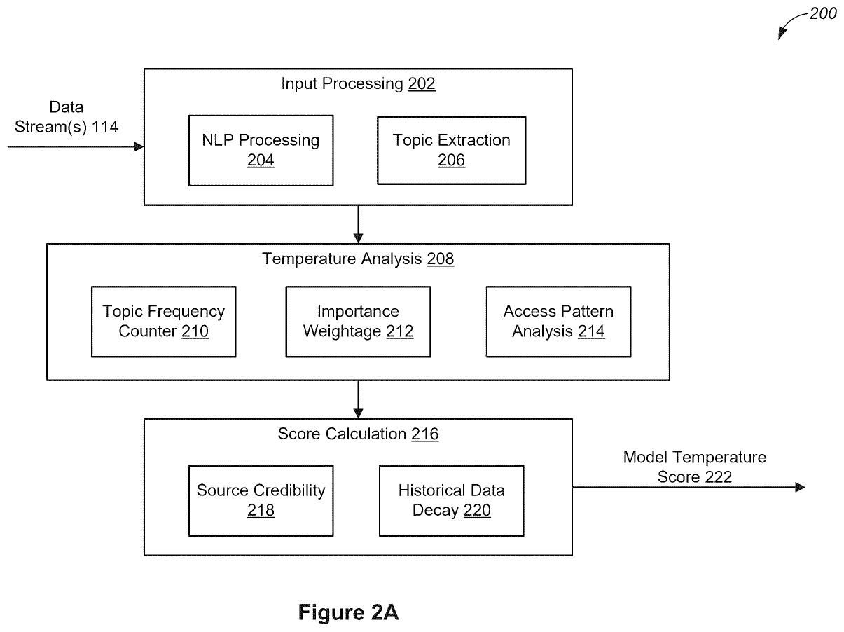

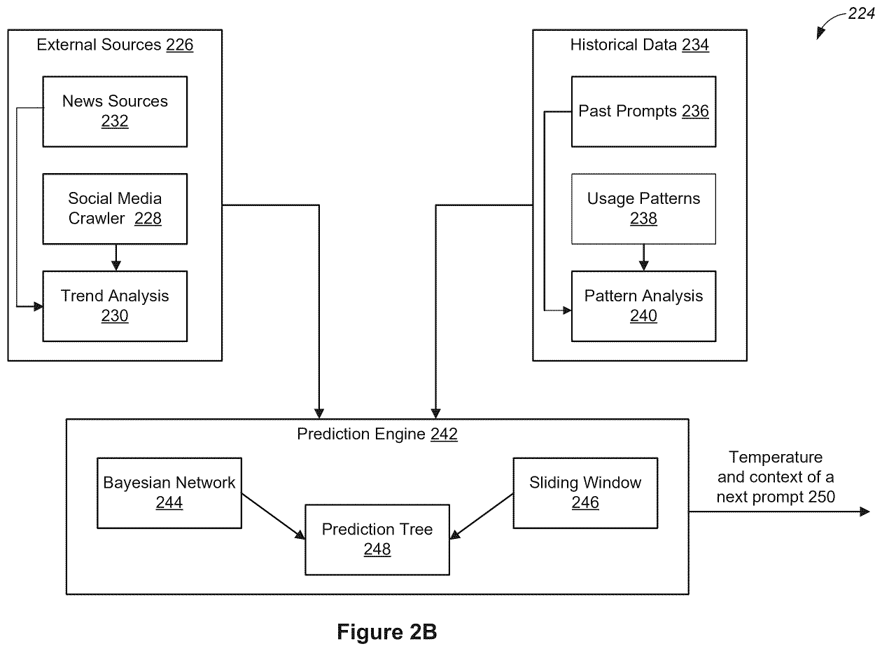

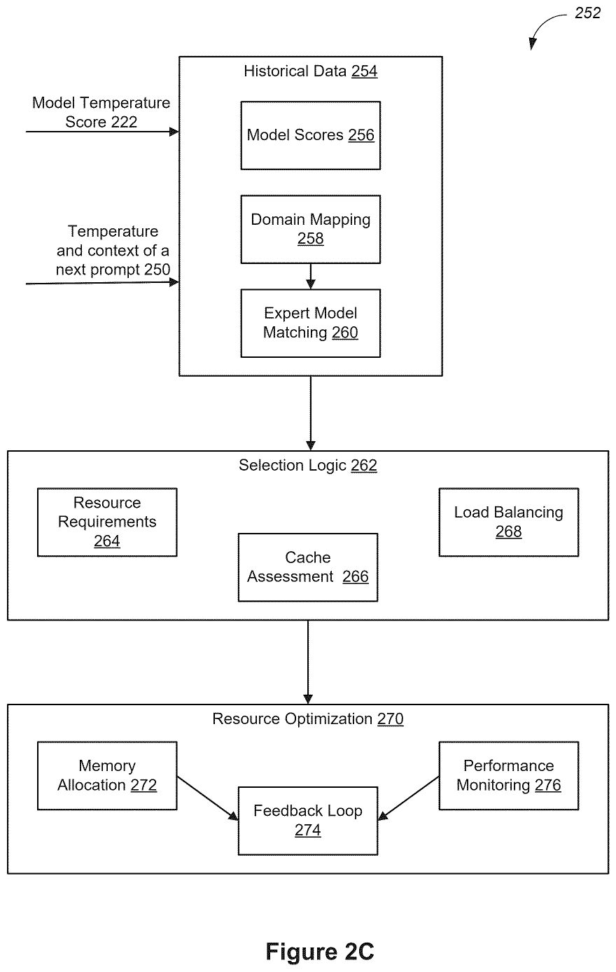

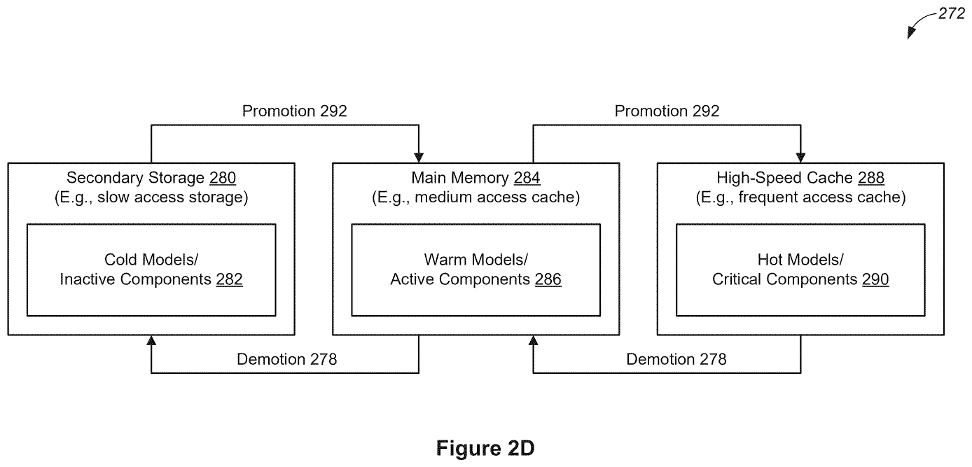

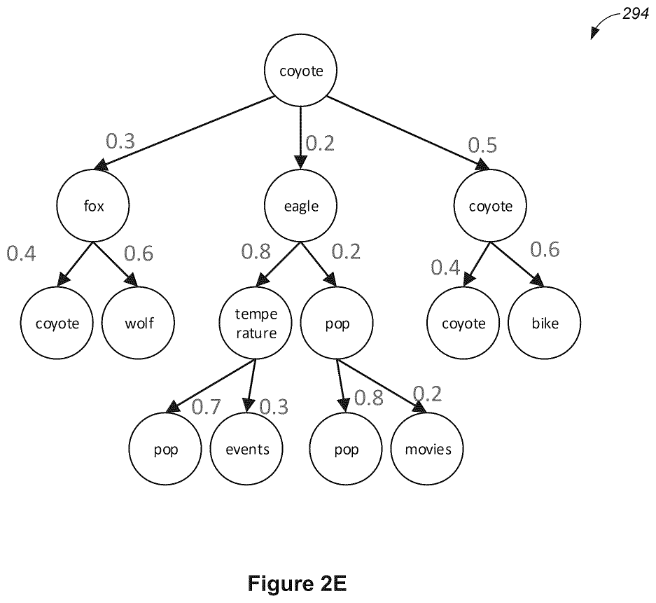

FIG. 2A is a schematic diagram of an example data temperature classification module 200, according to some embodiments. Input data streams 114 are processed through input processing 202, which includes natural language processing (NLP processing) 204 and topic extraction 206. Temperature analysis 208 is performed using multiple factors including topic frequency counter 210, importance weightage 212, and access pattern analysis 214. The score calculation 216 component considers additional factors like source credibility 218 and applies historical data decay 220 to generate a model temperature score 222.

In some embodiments, the data temperature classification module 200 tracks frequency of occurrence and/or frequency of access as metrics for temperature scoring. Frequency of occurrence represents how often a topic appears in the stored corpus, essentially measuring data popularity within the system. This metric can be calculated on a relative scale (such as 0-1 or 1-100) and dynamically adjusts as topics become more or less prevalent in the corpus. Similarly, frequency of access measures how often specific parts of the network or data are actively utilized, with frequently accessed data receiving higher “hotness” values. This access frequency also uses a relative scale and decreases as usage becomes less frequent. Importance weightage can incorporate machine learning approaches to determine feature significance when processing prompts. The system can use traditional statistical techniques like Principal Component Analysis (PCA) and Lasso regression, or leverage deep learning methods, such as transformer-based attention mechanisms. For example, when predicting power consumption in Arizona, the data temperature classification module 200 can consider multiple weighted features including direct historical consumption patterns, environmental conditions, seasonal factors, and social events like festivals or elections. These features can receive different importance weights based on their contribution to accurate predictions, with the most crucial features receiving the highest temperature scores on a relative scale (0-1 or 1-100).

The data temperature classification module 200 is responsible for analyzing a data stream that is feeding an AI application and identifying the temperature of incoming data (e.g., hotness quotient). Over time, this module will utilize features in the dataset to accurately estimate the temperature of incoming data points. Some of these features will include the topic or domain of an incoming data/prompt. Different techniques can be used to calculate data hotness. Some embodiments use a linear equation an example of which is shown below, where importance weights are calculated using the deep learning-based approaches (e.g., attention mechanism). Some embodiments use absolute values or normalized values of the frequency of occurrence, importance weightage, and/or frequency of access.

$$Data temperature = frequency of occurrence + importance weightage + frequency of access$$

In some embodiments, the system implements temperature scores on a normalized scale (e.g., from 0.0 to 1.0), calculated as weighted averages of the frequency metrics. The system classifies scores above a predetermined threshold (e.g., 0.8) as “very high temperature,” scores between a predetermined range (e.g., 0.5-0.8) as “high temperature,” scores between a another predetermined range (e.g., 0.2-0.5) as “moderate temperature,” and scores below a predetermined threshold (e.g., 0.2) as “cold.” These classifications can determine memory tier placement within the system. For example, very high temperature models are loaded into L1/L2 cache memory with access times under 10 nanoseconds, high temperature models reside in RAM with access times under 100 nanoseconds, and remaining models are distributed across progressively slower storage tiers according to their temperature classification.

In some embodiments, the system calculates importance weightage using an attention-based deep learning model that outputs normalized weights (e.g., between 0.0 and 1.0) for each topic. The calculation incorporates query volume at a predetermined weighting (e.g., thirty percent weighting), user engagement metrics including time spent and follow-up questions at another predetermined weighting (e.g., thirty percent weighting), cross-reference frequency across the corpus at another predetermined weighting (e.g., twenty percent weighting), and temporal relevance decay with a half-life (e.g., a seven-day half-life) at another weighting (e.g., twenty percent weighting). This weighted combination can help ensure comprehensive evaluation of topic importance across multiple dimensions of user interaction and temporal relevance.

In some embodiments, data temperature can also use more sophisticated algorithms that take into account the source of the query and a sliding window. This would allow the system to forget temporarily hot topics that can arise on a day/week/month to fade later and smooth out spikes. Alternatively, or additionally, this module can map the temperature of input data to the relevant expert model that is used for processing, which allows the AI models to be ranked by temperature. In some embodiments, model temperatures are updated to reflect any changes in the data stream. An expert model can answer questions in sub-topics, which the system can potentially weigh differently to smooth out spikes in narrow areas. For example, after a coyote sighting in an area, many queries may come in asking about a coyote, that can mean that the hotness of the coyote topic and wildlife expert model is short lived, while consistent prompts for wildlife animals during peak hiking and camping season has a longer timescale. In some embodiments, each input prompt is paired with the predicted prompt and shared with the next prompt prediction module.

In some embodiments, the system implements the sliding window using an exponential moving average with a predetermined alpha value (e.g., 0.2) over a time period (e.g., twenty-four-hour period), with dynamic adjustment based on topic volatility. The window size automatically expands (e.g., to seventy-two hours) during stable periods when the standard deviation of scores remains below a predetermined threshold (e.g., 0.1), and contracts (e.g., to six hours) during volatile periods when the standard deviation exceeds a predetermined threshold (e.g., 0.3). This adaptive window sizing ensures optimal balance between stability and responsiveness.

Various specific examples (e.g., for threshold, range, weighting) mentioned with reference to FIG. 2A are provided solely for illustrative purposes, and not intended to be exhaustive or to limit the scope of the inventions to the precise examples disclosed. Many modifications and variations of the examples are possible in view of the above teachings.

FIG. 2B is a schematic diagram of an example next prompt prediction module 224, according to some embodiments. In some embodiments, the next prompt prediction module 224 processes input from external sources 226, including a social media crawler 228 and news sources 232, through trend analysis 230. Historical data 234, including past prompts 236 and usage patterns 238, feeds into pattern analysis 240. A prediction engine 242 utilizes a Bayesian network 244 (or any deep-learning based technique), sliding window 246, and/or prediction tree 248 to generate temperature and context predictions for the next prompt 250. In some embodiments, the next prompt prediction module 224 incorporates query context analysis to differentiate between automated system queries and human-generated queries. This analysis examines query patterns, formatting, timing intervals, and language characteristics to determine the source context. The system can maintain separate pattern databases and applies different prediction strategies based on whether the source is automated or human. The next prompt prediction module 224 is responsible for learning, based on feedback from the data temperature prediction module, patterns in the input data to predict the temperature and context of the next prompt. Instead of, or in addition to, predicting a semantically accurate prompt, the next prompt prediction module predicts the likelihood of the next prompt containing a hot topic. That likelihood or the probability can be quantified by a similarity score, such as cosine similarity, between the embedding vector of input data versus previously seen hot topics. The next prompt prediction module 224 can use techniques that rely on conditional probabilities, such as Bayes networks or other AI techniques that support memory since the events are often correlated. Some embodiments crawl social media and/or other public news sources to determine if a certain topic is gaining popularity to predict queries.

In some embodiments, the sliding window implementation uses an exponentially weighted moving average (EWMA) to smooth out anomalies in the data stream. For example, for each time period t, the system calculates a smoothed temperature score S(t) using the formula S(t)=αT(t)+(1−α)S(t−1), where T(t) is the current temperature score, S(t−1) is the previous smoothed value, and α is a smoothing factor between 0 and 1. The system can use α=0.2, for example, to give more weight to historical patterns while still remaining responsive to new trends. The window size can be dynamically adjusted based on the variance in temperature scores, with larger windows (e.g., 24 hours) used during periods of high volatility and smaller windows (e.g., 1 hour) during stable periods. This adaptive window sizing can prevent both over-reaction to temporary spikes and under-reaction to genuine trend changes.

FIG. 2C a schematic diagram of an example dynamic model loader 252, according to some embodiments. The dynamic model loader 252 receives the model temperature score 222 data temperature classification module 200 and the temperature and context of a next prompt 250 from the next prompt prediction module 224. Historical data 254, which may include a storage infrastructure, such as a database, can obtain and/or store model scores 256, domain mapping 258, which may be used for expert model matching 260. The historical data 254 is input to a selection logic 262, which takes into account resource requirements 264, cache assessment 266, and/or load balancing 268, for selecting AI models for preloading. The resource requirements can include the computational and memory resources needed to load and run a specific AI model, such as memory space, processing power, and other system resources. The cache assessment 266 can include the evaluation of what models or model components are currently stored in the cache memory and how effectively (e.g., frequency of use) the models are being used. The load balancing 268 can include the distribution of AI models across available memory and processing resources to avoid overloading any single component of the system. The dynamic model loader 252 also includes resource optimization connected to the selection logic 262. The resource optimization 270 manages memory allocation 272 based on the input from the selection logic 262. The resource optimization 270 may include a feedback loop, for improving the memory allocation 272 based on performance monitoring 276, which can include the tracking of system performance metrics to evaluate how well the model loading and execution is working, used to provide feedback for improving memory allocation decisions. In some embodiments, the system's memory allocation strategy takes into account the query source context, for example, applying different caching and pre-loading strategies for automated system queries versus human-generated queries. Automated queries tend to follow more predictable patterns and can arrive at higher frequencies, requiring rapid data loading capabilities to maintain performance. In contrast, human-generated queries typically arrive at comparatively slower and more irregular intervals. The system can optimize memory management by implementing more aggressive pre-loading strategies for automated queries to handle their high-speed, high-volume nature, while employing different strategies for the comparatively lower-speed human queries.

The dynamic model loader 252 loads the appropriate model(s) based on the model temperature classifications from the data temperature classification module as well as the prompt predictions from the next prompt prediction module. In some embodiments, the dynamic model loader 252 ranks the available expert models by temperature and pre-loads (e.g., step 124, FIG. 1) the hottest models into memory. In some embodiments, the dynamic model loader 252 uses the prompt predictions to pre-load (e.g., step 106, FIG. 1) the specific model needed for the predicted prompt. In scenarios where the predicted prompt involves topics whose specialized models are not currently loaded in memory, the dynamic model loader uses an already-loaded model to avoid the overhead of loading and unloading new models. In the scenario of a hot topic predicted in the next prompt, the dynamic model loader 252 will pre-load the appropriate expert model to achieve the most accurate and performant response.

In the example described above in reference to FIG. 1, the data temperature classification module 200 has identified cold, warm, and hot topics based on historical data points. As a result, the models have also been assigned a temperature based on the domain of expertise. At TO, the data temperature classification module 200 receives an input prompt: “What is SRP's phone number”. At T1, that data point was identified as warm based on its similarity score to historically hot topics. At T2, the next prompt prediction module 224 uses the current and historical prompts 122 to predict that the next prompt would contain a hot topic and be related to power consumption. This enables the AI application 112 to optimally pre-load the relevant models into memory and utilize a tailored expert model when necessary.

In some embodiments, the dynamic resource allocation process implements a multi-factor optimization algorithm that considers, for example, current memory utilization across each tier of the memory hierarchy, historical load patterns for each model, current CPU utilization, and/or predicted resource requirements based on the temperature scores. For example, the system can use a weighted scoring function R=w₁*M+w₂*L+w₃*C+w₄*P, where M represents memory availability, L represents historical load, C represents current CPU capacity, and P represents predicted requirements. The weights w₁ through w₄ can be dynamically adjusted or can be learned parameters based on system performance metrics. When R exceeds a configurable threshold T, the system can trigger resource reallocation, which may include promoting models to faster memory tiers, increasing cache allocation for frequently accessed model components, and/or initiating parallel loading of predicted high-temperature models.

FIG. 2D is a schematic diagram of an example memory hierarchy 272 for model storage, in accordance with some embodiments. The hierarchy 272 includes three tiers: secondary storage 280 (e.g., slow access memory) for cold models and/or inactive components 282, main memory 284 for warm models and/or active components 286, and high-speed cache 288 for hot models and/or critical components 290. Models can be promoted 292 or demoted 278 between tiers based on their temperature scores. Some embodiments use the hotness of the model to load into different types of memory when available. For example, some embodiments load very hot models into the most expensive and fastest memory, while less hot models are loaded into the next level of the memory hierarchy 272, and so on.

FIG. 2E illustrates an example prediction tree 294 showing probability-based topic transitions, according to some embodiments. Some embodiments use prediction techniques to predict prompts beyond the next prompt, by building a prediction tree. Some embodiments use the prediction tree to example two or more hops and predict the overall hotness of certain expert model(s) based on the probability of these branches and the frequency of each topic. The example tree shown in FIG. 2 demonstrates how topics like “coyote” branch into different possible subsequent topics (fox, eagle, wolf) with associated probabilities, and further branches into different domains like “pop” and “temperature” with their respective probability weights. For the example shown in FIG. 2, the system predicts that after a prompt about “coyote” at TO, the next prompt can be in one of three areas with different probabilities. All three topics are in the wildlife expert model. Also, looking further in time, a high bias is shown towards more wildlife possibilities. Some embodiments use the cumulative probabilities to determine that the wildlife model is going to be very popular. At T1, if for example the next prompt was about eagle, then the system will traverse the second branch and compute additional probabilities, showing that the Pop expert model is the next candidate for hotness. Doing so can help the system anticipate model hotness at a wider scale and smooth out quick shift in interest. This is useful for avoiding swapping models in and out of memory too quickly, which can cause more delays.

In some embodiments, the system implements the prediction tree as a directed acyclic graph where each node represents a topic with its associated temperature score. For example, the system assigns edge weights based on transition probabilities derived from historical data. In some embodiments, the system prunes paths when their cumulative probability falls below a predetermine value (e.g., 0.1) and limits tree depth (e.g., to five levels) while maintaining a minimum cumulative probability threshold (e.g., 0.01). This structured approach enables efficient prediction of topic sequences.

Various specific examples (e.g., for topics, domains, numerical values) mentioned with reference to FIG. 2E are provided solely for illustrative purposes, and not intended to be exhaustive or to limit the scope of the inventions to the precise examples disclosed. Many modifications and variations of the example technique are possible in view of the above teachings.

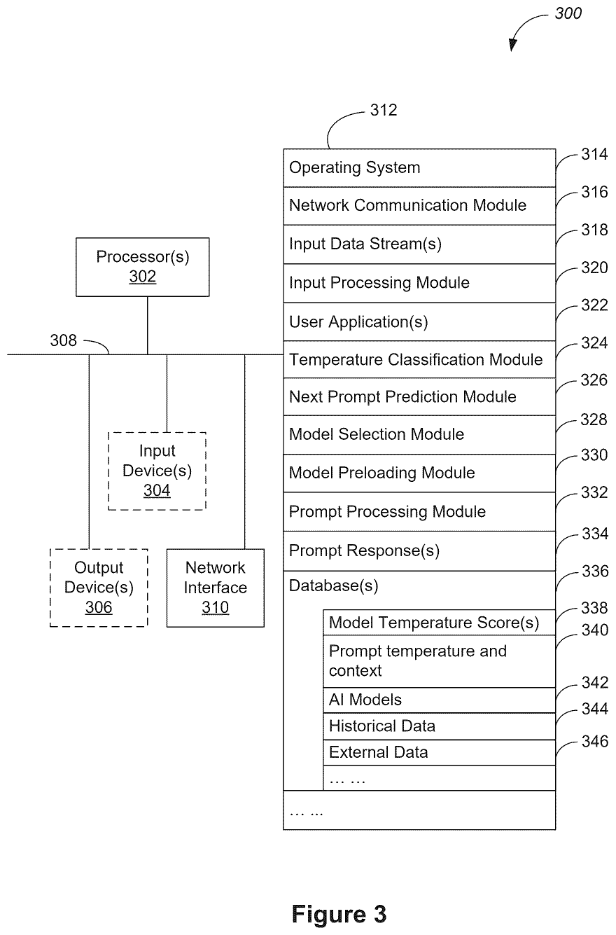

FIG. 3 shows a block diagram of an example computing device 300 for optimizing artificial intelligence (AI) model selection and loading, according to some embodiments. The computing device 200 includes one or more processors 302 for executing instructions and processing data. These may include CPUs, GPUs, and/or specialized processors for tasks like image processing. The computing device 300 also includes a memory 312, a storage for data and instructions, which may include high-speed random access memory and non-volatile storage like flash memory or solid-state drives. The computing device 300 also includes a communication bus 308, which may include one or more interconnects connecting the various hardware components, allowing data transfer between them. The computing device 200 may also include communication interface(s) 310, which enable network connectivity, potentially including Wi-Fi, Bluetooth, or wired connections for data transfer and API communications. The computing device 300 may also include input devices 304 shown as an optional component (dashed lines), which may include controllers, hand-tracking sensors, and/or other mechanisms for user interaction. The computing device 300 may also include one or more output devices 306 (e.g., a display). The computing device 300 may also include power supply, for providing power to the system, which may be a battery for portable use or a connection to a main power.

In some embodiments, the memory 312 includes high-speed random access memory, such as DRAM, SRAM, DDR RAM, and/or other random access solid state memory devices. In some embodiments, the memory 312 includes non-volatile memory, such as one or more magnetic disk storage devices, optical disk storage devices, flash memory devices, or other non-volatile solid state storage devices. In some embodiments, the memory 312 includes one or more storage devices remotely located from the processor(s) 302. The memory 312, or alternatively the non-volatile memory device(s) within the memory 312, comprises a computer readable storage medium. Memory for headsets include, for example, Random Access Memory (RAM), such as Low Power Double Data Rate RAM (LPDDR), used for running the operating system, applications, and/or handling real-time data processing. Memory 312 may also include storage memory, such as flash memory, similar to smartphones (e.g., eMMC or UFS), for storing the operating system, applications, and/or user data. Video memory, often integrated with the GPU in mobile chipsets, can be used to handle graphics processing tasks. Cache memory, such as Static RAM (SRAM), can be used for high-speed memory used by the processors 312 for data access.

In some implementations, the memory 312 stores one or more programs (e.g., sets of instructions), and/or data structures, collectively referred to as “modules” herein. In some implementations, the memory 312, or the non-transitory computer readable storage medium of the memory 312, stores the following programs, modules, and data structures, or a subset or superset thereof:
on operating system 314, which manages system resources and/or processes, and/or provide a platform for other software components;
a network communications module 316, which handles network communications, may be using protocols suitable for real-time data exchange;
input data streams 318;
an input processing module 320;
user applications 322, which may include AI applications (e.g., the AI application 112);
a temperature classification module 324 (e.g., the temperature classification module 200);
a next prompt prediction module 326 (e.g., the next prompt prediction module 224);
a model selection module 328 (e.g., the model selection logic 262);
a model preloading module 330 (e.g., the memory preloading module 252);
a prompt processing module 332;
prompt responses 334; and/or
databases 336, which includes model temperature score(s) 338, prompt temperature and context 340, AI models 342, historical data 344, and/or external data 346.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise rearranged in various implementations. In some embodiments, the memory 312 stores a subset of the modules and data structures identified above. Furthermore, in some embodiments, the memory 312 stores additional modules or data structures not described above. Example details and/or operations of the modules, data structures, applications and/or procedures, are further described below, according to some embodiments. Although FIG. 3 shows a computing device, FIG. 3 is intended more as a functional description of the various features that may be present rather than as a structural schematic of the implementations described herein. In practice, and as recognized by those of ordinary skill in the art, items shown separately could be combined and some items could be separated.

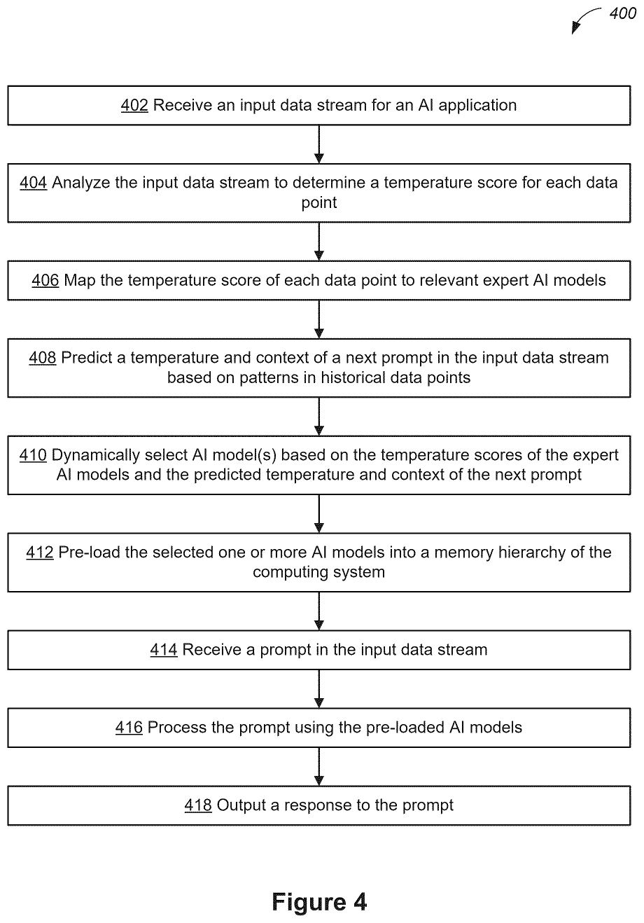

FIG. 4 is a flowchart of an example method 400 for optimizing AI model selection and loading, according to some embodiments. The method 400 can be performed by the computing system 300. The computing device 300, through its processor(s) 302 and memory 312, executes a method for optimizing AI model selection and loading.

The input processing module 320 receives (402) an input data stream through input device(s) 304 for an AI application 322. In some embodiments, the input processing module 320 uses natural language processing techniques to extract and classify topics from unstructured text data, enabling temperature score calculation for diverse input formats. The natural language processing techniques can include topic extraction and classification from unstructured text data, enabling adaptive temperature score calculation for diverse and evolving input formats. In some embodiments, the system uses the underlying language model's existing natural language processing capabilities to extract and classify topics from the input data stream, without implementing additional topic extraction methods.

The temperature classification module 324 analyzes (404) the input data stream to determine a temperature score for each data point. The temperature classification module 324 calculates the temperature score based on: (a) frequency of occurrence of topics within the data point, (b) importance weightage of the topics, and (c) frequency of access of the topics. In some embodiments, the temperature classification module 324 calculates the temperature score is calculated using the equation:

$$data temperature = frequency of occurrence of topics within data points + importance weightage of thetopics + frequency of access of the topics .$$

In some embodiments, the temperature classification module 324 calculates importance weightage using one or more deep learning-based techniques (e.g., a technique that incorporates an attention mechanism). In some embodiments, the system 100 is model-agnostic and can utilize any suitable AI model architecture, with importance weightage calculation leveraging the underlying training and capabilities of the utilized large language model and its pre-trained corpus, rather than implementing specific new architectures or training methods. The module continuously updates the importance weightage based on the context of user queries and internal usage patterns for answering queries. In some embodiments, the temperature classification module 324 factors in the source of the data point (e.g., whether the data point originates from an automated system query or a human-generated query) when calculating temperature scores. In some embodiments, the temperature classification module 324 leverages the underlying large language model's built-in topic extraction and contextual understanding capabilities to identify and classify topics within the data stream, while calculating and combining temperature scores from the identified topic frequencies, importance weights, and access patterns.

The temperature classification module 324 maps (406) the temperature score of each data point to relevant expert AI models 342. In some embodiments, the temperature classification module 324 updates the temperature classification of expert AI models based on changes in the data stream temperature over time. The module applies a decay function to historical data points in the temperature score calculation, weighting more recent data points more heavily than older data points to reflect current trends. In some embodiments, the system uses two complementary mechanisms for managing historical data: a decay function that removes old topics from consideration over time, and a sliding window that bases decisions on multiple recent requests rather than single data points. These mechanisms can work together (or separately) to maintain relevant temperature scores while preventing outdated topics from influencing model selection. In some embodiments, the temperature classification module 324 generates a heat map visualization of topic temperatures over time, which the model selection module 328 uses to identify trends and patterns in data stream content for long-term model optimization. In some embodiments, the system 300 uses standard heatmap visualization techniques to display keyword frequencies and temperature patterns over time. For example, darker colors can represent higher frequencies and temperatures, enabling visual tracking of topic trends for optimization purposes.

The next prompt prediction module 326 predicts (408) a temperature and context of a next prompt in the input data stream based on patterns in the historical data 344. The next prompt prediction module 326 utilizes a sliding window to smooth out temporary spikes or anomalies. In some embodiments, the next prompt prediction module 326 uses one or more deep learning-based techniques (e.g., a Bayesian network) to model temporal patterns and conditional probabilities based on historical prompt sequences stored in the historical data 344. In some embodiments, the network communications module 316 crawls social media and public news sources to collect external data 346, which the next prompt prediction module 326 uses to identify rapidly gaining topics for incorporation into next prompt predictions. Crawling social media and public news sources may include continuous monitoring of multiple platforms, with dynamic adjustment of topic importance based on identified trends and cross-platform corroboration. The temperature classification module 324 determines the credibility and relevance of the identified topics based on their popularity and frequency of occurrence across multiple sources.

In some embodiments, the next prompt prediction module 326 uses standard Bayesian network implementations to model probabilistic relationships between topics and prompt sequences, focusing on the novel integration of these probabilities into the temperature-based model selection framework rather than the underlying probability calculations themselves. When encountering previously unseen topics or sequences, the next prompt prediction module 326 leverages existing probabilistic relationships to make informed predictions about potential model requirements, while continuously updating its probability estimates as new data becomes available. In some embodiments, when predictions significantly deviate from actual prompts, the system implements a learning mechanism to improve future predictions. This mechanism can calculate deviation scores between predicted and actual prompts, analyze contextual factors contributing to the mismatch, and update the probability estimation parameters accordingly. The system 300 can employ various probability estimation algorithms to perform these calculations and updates—for example, a Bayesian network approach could update its network probabilities and temperature scoring weights, while other probability estimation algorithms could be used as well. The system can maintain a prediction accuracy log to track these deviations and resulting adjustments, enabling continuous refinement of the prediction algorithm.

In some embodiments, the next prompt prediction module 326 predicts prompts beyond the next prompt to create a prediction tree for determining cumulative probabilities of topic occurrence. The model selection module 328 uses these cumulative probabilities to anticipate model hotness over an extended time period to optimize model swapping frequency. Predicting prompts beyond the next prompt creates a multi-level prediction structure for determining cumulative probabilities of topic occurrence, enabling the system to anticipate and prepare for a range of potential future queries. In some embodiments, the next prompt prediction module 326 logs the accuracy of next prompt predictions in historical data 344 and uses this logged data to refine its prediction algorithm over time. In some embodiments, the system uses a feedback-based accuracy measurement approach, where prediction success is determined by whether the pre-loaded models were sufficient for handling the actual prompt or if unanticipated model loading was required. This binary success/failure metric can directly informs the system's predictive performance without requiring complex accuracy calculations.

The model selection module 328 dynamically selects (410) one or more AI models based on the temperature scores stored in model temperature score(s) 338 and the predicted temperature and context stored in prompt temperature and context 340. In some embodiments, the model selection module 328 implements a caching mechanism for frequently used model components, enabling partial model loading to improve response time for hybrid queries spanning multiple expert domains.

The model preloading module 330 pre-loads (412) the selected AI models into the memory hierarchy 272 of the computing system 300, placing models with higher temperature scores into faster memory. In some embodiments, when pre-loading AI models, the model preloading module 330 ranks available expert models by temperature. The module loads very high temperature models into the fastest available memory tier of memory 312, and places lower temperature models into progressively slower memory tiers. The module implements a caching mechanism for frequently used model components, enabling partial model loading to improve response time for hybrid queries spanning multiple expert domains. In some embodiments, the model preloading module 330 manages a memory hierarchy 272 comprising at least three tiers of memory with different access speeds within memory 312. The module distributes AI models across the tiers based on their respective temperature scores stored in model temperature score(s) 338. In some embodiments, the memory hierarchy 272 comprises multiple tiers with different access speeds, and the pre-loading step optimizes model distribution across the tiers based on their respective temperature scores, thereby improving overall system responsiveness. In some embodiments, the model preloading module 330 dynamically allocates computational resources based on the calculated temperature scores and predicted prompt contexts, optimizing system performance and efficiency.

The prompt processing module 332 receives (414) and processes (416) the next prompt using the pre-loaded AI models, and outputs (418) a response (e.g., the prompt response 334) through output device(s) 306. In some embodiments, the prompt processing module 332 utilizes a less accurate, already-loaded model for non-critical or cold topics to avoid loading and unloading a specialized cold model. In some embodiments, the system 300 defines non-critical topics through multiple quantitative criteria. For example, non-critical topics must have temperature scores below 0.2, no active user sessions requiring response, historical accuracy tolerance exceeding twenty percent based on application parameters, and no security or safety implications as determined by content classifiers. This definition enables appropriate handling of lower-priority topics while maintaining system efficiency.

In some embodiments, the system uses a straightforward classification approach where any model not currently loaded or recently accessed in the memory hierarchy 272 is considered “cold,” while maintaining loaded models represents active or “hot” states, enabling efficient decision-making about whether to load specialized models or use existing ones for prompt processing. In some embodiments, the prompt processing module 332 implements a feedback loop where it uses the accuracy and relevance of AI model responses to dynamically adjust the temperature scores of both the input data and the corresponding expert models stored in model temperature score(s) 338. In some embodiments, the system 300 uses standard accuracy metrics from AI feedback mechanisms, using response outcomes as ground truth to validate and adjust temperature scores, for temperature-based model selection. The feedback loop continually refines the model selection process, adaptively improving system performance over time. In some embodiments, the system 300 operates the feedback loop using a rolling window (e.g., a window of one thousand prompts), implementing accuracy scoring based on user feedback. In some embodiments, the system 300 limits temperature score adjustments to a maximum value (e.g., 0.1) per feedback cycle and requires a minimum number of samples (e.g., fifty feedback samples) before making adjustments. This controlled feedback mechanism helps ensure stable yet responsive temperature score evolution.

In some embodiments, the computing system 300 uses a simple but effective initialization approach where new topics start with a temperature score of zero unless social media crawling indicates emerging relevance. In some embodiments, the system 300 performs credibility scoring for social media and news sources through cross-validation across independent sources. For example, the system 300 incorporates source authority ranking based on historical accuracy, tracks topic velocity through change in mention frequency over time, and/or normalizes engagement metrics by source follower count. This methodology helps ensure reliable trend detection and importance assessment. To manage model loading efficiency, the system uses sliding windows and decay functions to smooth out temporary fluctuations, while handling multi-topic queries through parallel processing of separate topic domains. The system may assume that adequate computational resources are available to handle the concurrent processing demands of temperature scoring, Bayesian predictions, and model loading operations. In some embodiments, the computing system 300 improves processing speed and accuracy of the AI application 322 by anticipating and pre-loading relevant AI models based on dynamically calculated temperature scores and next prompt predictions.

In this way, the method 400 significantly improves processing efficiency and reduces latency by dynamically selecting and pre-loading AI models based on calculated temperature scores and predicted usage patterns; the analyzing, predicting, and pre-loading steps are performed continuously as the input data stream is received, enabling real-time adaptation to changing data patterns. In some embodiments, the method 400 leverages high-speed parallel processing to handle massive data streams while simultaneously executing complex Bayesian probability calculations and managing multi-tiered memory architectures. These operations can require processing millions of data points per second. Through continuous real-time analysis of streaming data, the system can orchestrate precision-timed model loading across specialized memory hierarchies, coordinates concurrent data temperature calculations across multiple processors, and maintains synchronized model states across distributed computing resources. The computational intensity of these coordinated operations, which can involve processing terabytes of model parameters while maintaining sub-millisecond response times, demonstrates the method's sophisticated technical infrastructure that addresses fundamental computing challenges in artificial intelligence systems.

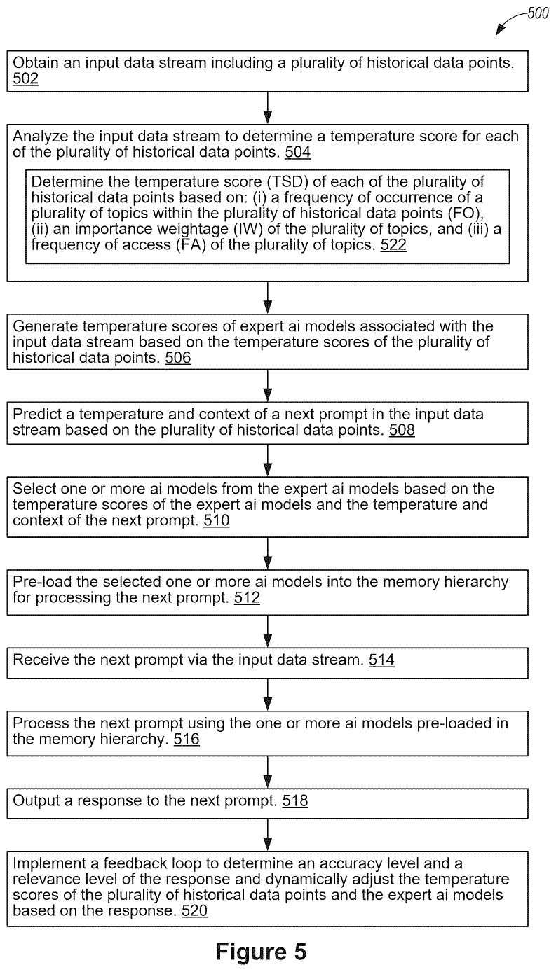

FIG. 5 is a flowchart of another example method 500 for AI model selection and loading, according to some embodiments. For convenience, the method 500 is described as being implemented by a computing system 300. Method 500 is, optionally, governed by instructions that are stored in a non-transitory computer readable storage medium and that are executed by one or more processors of the computing system. Each of the operations shown in FIG. 5 may correspond to instructions stored in a computer memory or non-transitory computer readable storage medium (e.g., memory 312 in FIG. 3). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 500 may be combined and/or the order of some operations may be changed.

The computing system 300 includes one or more processors and a memory hierarchy 272 (FIG. 2D). The computer system obtains (operation 502) an input data stream 114 including a plurality of historical data points, and analyzes (operation 504) the input data stream 114 to determine a temperature score for each of the plurality of historical data points. The computing system 300 generates (operation 506) temperature scores of expert AI models (e.g., M1, M2, M3, and M4 in FIG. 1) associated with the input data stream 114 based on the temperature scores of the plurality of historical data points. A temperature and context 250 (e.g., in FIG. 2B) of a next prompt 120 in the input data stream 114 is predicted (operation 508) based on the plurality of historical data points, and the computing system 300 selects (operation 510) one or more AI models from the expert AI models based on the temperature scores of the expert AI models and the temperature and context 250 of the next prompt 120. The selected one or more AI models are pre-loaded (operation 512) into the memory hierarchy 272 for processing the next prompt 120.

In some embodiments, the computing system 300 receives (operation 514) the next prompt 120 via the input data stream 114, processes (operation 516) the next prompt 120 using the one or more AI models pre-loaded in the memory hierarchy 272, and outputs (operation 518) a response to the next prompt 120. Further, in some embodiments, the computing system 300 implements (operation 520) a feedback loop 274 (FIG. 2C) to determine an accuracy level and a relevance level of the response and dynamically adjust the temperature scores of the plurality of historical data points and the expert AI models based on the response.

In some embodiments, when the computing system 300 predicts the temperature and context 250 of the next prompt 120, the computing system 300 applies a sliding window to smooth out one or more temporary spikes or anomalies. In some embodiments, when the computing system 300 predicts the temperature and context 250 of the next prompt 120, the computing system 300 identifies, in the input data stream 114, one or more historical prompt sequences each including a set of historical prompts and applies one or more deep learning-based techniques to model a temporal pattern and one or more conditional probabilities based on the one or more historical prompt sequences.

In some embodiments, the computing system 300 crawls public sources (e.g., social media and news sources) to identify one or more supplemental topics. The temperature score of each of the plurality of historical data points is determined based on information of the one or more supplemental topics. A quality score is determined indicate credibility and relevance of the one or more supplemental topics based on a frequency of occurrence across the public sources.

In some embodiments, when the computing system 300 pre-loads the selected AI models, the computing system 300 ranks the expert models based on the temperature scores of the expert AI models, determines that the temperature score of each of a first subset of expert models is equal to or higher than the temperature score of each remainder AI model that is not included in the first subset of expert models, and loading the first subset of expert models into a top memory tier (e.g., high-speed cache 288 in FIG. 2D). One or more remainder AI models are loaded into one or more memory tiers (e.g., memories 280, 284, and 288) based on their temperature scores, and the one or more remainder AI models correspond to a plurality of non-overlapping ranges of temperature scores. The top memory tier has a top memory access rate that is greater than a respective memory access rate of each of the one or more memory tiers.

In some embodiments, the computing system 300 predicts one or more supplemental prompts distinct from the next prompt 120, creates a prediction tree 294 (FIG. 2E) including the next prompt 120 and the one or more supplemental prompts, determines one or more cumulative probabilities of topic occurrence based on the prediction tree 294, and applies the one or more cumulative probabilities to determine a model hotness over an extended time period and control a model swapping frequency.

In some embodiments, a specialized cold model is not loaded in the memory hierarchy 272, and configured to provide an accuracy level that is higher than that of the one or more AI models. The computing system 300 receives the next prompt 120 via the input data stream 114, and processes the next prompt 120 using the one or more AI models pre-loaded in the memory hierarchy 272. The specialized cold model is not applied to process the next prompt 120.

In some embodiments, the computer system determines (operation 522) the temperature score (TSD) of each of the plurality of historical data points based on: (i) a frequency of occurrence of a plurality of topics within the plurality of historical data points (FO), (ii) an importance weightage 212 (IW) of the plurality of topics, and (iii) a frequency of access (FA) of the plurality of topics. Further, in some embodiments, the temperature score of each of the plurality of historical data points is determined as follows:

$$T S D = F O + I W + F A .$$

Additionally, in some embodiments, the importance weightage 212 is calculated using one or more deep learning-based techniques, and continuously updated based on a plurality of user queries and an internal usage pattern associated with the plurality of user queries.

In some embodiments, the computing system 300 tracks a data stream temperature as a weighted combination of the temperature scores of the plurality of historical data points, and respective weights of the plurality of historical data points decrease with respect to respective recency levels in accordance with a decay function (e.g., in historical data decay 220 in FIG. 2A). A temperature classification of the expert AI models is updated based on a temporal variation of the data stream temperature.

In some embodiments, the plurality of historical data points have a plurality of input formats including unstructured text data, and correspond to a plurality of topics. The temperature scores of the plurality of historical data points are determined for the plurality of input formats. The computing system 300 analyzes the input data stream 114 using a natural language processing technique 204 to extract and classify the plurality of topics from the unstructured text data.

In some embodiments, the temperature score for each of the plurality of historical data points is further determined based on whether the respective data point originates from an automated system query or a human-generated query.

In some embodiments, the plurality of historical data points correspond to a plurality of topics. The computing system 300 generates a plurality of topic temperatures of the plurality of topics based on the temperature scores of the plurality of historical data points, and generates a heat map visualization of the plurality of topic temperatures over time. The heat map visualization is configured to identify a trend or a patterns in the input data stream 114.

In some embodiments, the memory hierarchy 272 includes at least three tiers of memory (e.g., memories 280, 284, and 288 in FIG. 2D) with different access speeds. When the computing system 300 pre-loads the selected one or more AI models, the computing system 300 distributes the selected one or more AI models across the at least three tiers of memory based on the respective temperature scores. The higher the respective temperature score of a selected AI model, the faster the memory access speed of a tier of memory where the selected AI model is pre-loaded.

In some embodiments, a prediction algorithm is used to predict the temperature and context 250 of the next prompt 120. The computing system 300 determines an accuracy level of a reply provided by the selected one or more AI models in response to the next prompt 120, and refines a prediction algorithm based on the accuracy level of the reply to the next prompt 120.

In some embodiments, when the computing system 300 selects the one or more AI models, the computing system 300 implements a caching mechanism for frequently used model components 290. The frequently used model components 290 correspond to a plurality of expert domains, and are partially loaded to improve a response time to hybrid queries spanning the plurality of expert domains.

In some embodiments, the input data stream 114 is obtained for an AI application 112 (FIG. 1), and a processing speed and an accuracy level of the AI application 112 are controlled in response to selection and pre-loading of the selected one or more AI models based on the temperature score of each of the plurality of historical data points and the temperature and context 250 of the next prompt 120.

In some embodiments, the computing system 300 dynamically allocates computational resources based on the temperature and context 250 of the next prompt 120.

It should be understood that the particular order in which the operations in FIG. 5 have been described are merely exemplary and are not intended to indicate that the described order is the only order in which the operations could be performed. One of ordinary skill in the art would recognize various ways to select and load AI models. Additionally, it should be noted that details of other processes described above with respect to FIGS. 1-4 are also applicable in an analogous manner to method 500 described above with respect to FIG. 5. For brevity, these details are not repeated here.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

The foregoing description, for purpose of explanation, has been described with reference to specific implementations. However, the illustrative discussions above are not intended to be exhaustive or to limit the scope of the claims to the precise forms disclosed. Additionally, the foregoing description, for purpose of explanation, has been described with reference to specific numerical examples (e.g., associated with performance metrics, resource utilization efficiency, and/or task-specific requirements). However, the illustrative discussions above are not intended to be exhaustive or to limit the scope of the claims to the precise numerical examples disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A computer-implemented method for applying artificial intelligence (AI) models, comprising:
at a computing system having one or more processors and a memory hierarchy:
obtaining an input data stream including a plurality of historical data points;
analyzing the input data stream to determine a temperature score for each of the plurality of historical data points;
generating temperature scores of expert AI models associated with the input data stream based on the temperature scores of the plurality of historical data points;
predicting a temperature and context of a next prompt in the input data stream based on the plurality of historical data points;
selecting one or more AI models from the expert AI models based on the temperature scores of the expert AI models and the temperature and context of the next prompt; and
pre-loading the selected one or more AI models into the memory hierarchy for processing the next prompt.

2. The method of claim 1, wherein predicting the temperature and context of the next prompt further comprises:
applying a sliding window to smooth out one or more temporary spikes or anomalies;
identifying, in the input data stream, one or more historical prompt sequences each including a set of historical prompts; and
applying one or more deep learning-based techniques to model a temporal pattern and one or more conditional probabilities based on the one or more historical prompt sequences.

3. The method of claim 1, further comprising:
crawling public sources to identify one or more supplemental topics, wherein the temperature score of each of the plurality of historical data points is determined based on information of the one or more supplemental topics; and
determining a quality score indicating credibility and relevance of the one or more supplemental topics based on a frequency of occurrence across the public sources.

4. The method of claim 1, wherein pre-loading the selected AI models comprises:
ranking the expert models based on the temperature scores of the expert AI models;
determining that the temperature score of each of a first subset of expert models is equal to or higher than the temperature score of each remainder AI model that is not included in the first subset of expert models;
loading the first subset of expert models into a top memory tier;
loading one or more remainder AI models into one or more memory tiers based on their temperature scores, wherein the one or more remainder AI models correspond to a plurality of non-overlapping ranges of temperature scores; and
wherein the top memory tier has a top memory access rate that is greater than a respective memory access rate of each of the one or more memory tiers.

5. The method of claim 1, further comprising:
predicting one or more supplemental prompts distinct from the next prompt;
creating a prediction tree including the next prompt and the one or more supplemental prompts;
determining one or more cumulative probabilities of topic occurrence based on the prediction tree; and
applying the one or more cumulative probabilities to determine a model hotness over an extended time period and control a model swapping frequency.

6. The method of claim 1, wherein a specialized cold model is not loaded in the memory hierarchy, and configured to provide an accuracy level that is higher than that of the one or more AI models, the method further comprising:
receiving the next prompt via the input data stream; and
processing the next prompt using the one or more AI models pre-loaded in the memory hierarchy, wherein the specialized cold model is not applied to process the next prompt.

7. The method of claim 1, further comprising:
determining the temperature score (TSD) of each of the plurality of historical data points based on: (i) a frequency of occurrence of a plurality of topics within the plurality of historical data points (FO), (ii) an importance weightage (IW) of the plurality of topics, and (iii) a frequency of access (FA) of the plurality of topics using the following equation:
$$T S D = F O + I W + F A .$$

8. The method of claim 7, wherein the importance weightage is calculated using one or more deep learning-based techniques, and continuously updated based on a plurality of user queries and an internal usage pattern associated with the plurality of user queries.

9. The method of claim 1, further comprising:
tracking a data stream temperature as a weighted combination of the temperature scores of the plurality of historical data points, wherein respective weights of the plurality of historical data points decrease with respect to respective recency levels in accordance with a decay function; and
updating a temperature classification of the expert AI models based on a temporal variation of the data stream temperature.

10. The method of claim 1, wherein:
the plurality of historical data points have a plurality of input formats including unstructured text data, and correspond to a plurality of topics;
the temperature scores of the plurality of historical data points are determined for the plurality of input formats; and
analyzing the input data stream further comprises using a natural language processing technique to extract and classify the plurality of topics from the unstructured text data.

11. A computing system, comprising:
one or more processors;
a memory hierarchy;
memory storing one or more programs configured for execution by the one or more processors, the one or more programs comprising instructions for:
obtaining an input data stream including a plurality of historical data points;
analyzing the input data stream to determine a temperature score for each of the plurality of historical data points;
generating temperature scores of expert AI models associated with the input data stream based on the temperature scores of the plurality of historical data points;
predicting a temperature and context of a next prompt in the input data stream based on the plurality of historical data points;
selecting one or more AI models from the expert AI models based on the temperature scores of the expert AI models and the temperature and context of the next prompt; and
pre-loading the selected one or more AI models into the memory hierarchy for processing the next prompt.

12. The computing system of claim 11, the one or more programs further comprising instructions for:
receiving the next prompt via the input data stream;
processing the next prompt using the one or more AI models pre-loaded in the memory hierarchy;
outputting a response to the next prompt; and
implementing a feedback loop to determine an accuracy level and a relevance level of the response and dynamically adjust the temperature scores of the plurality of historical data points and the expert AI models based on the response.

13. The computing system of claim 11, wherein the temperature score for each of the plurality of historical data points is further determined based on whether the respective data point originates from an automated system query or a human-generated query.

14. The computing system of claim 11, wherein the plurality of historical data points correspond to a plurality of topics, the one or more programs further comprising instructions for:
generating a plurality of topic temperatures of the plurality of topics based on the temperature scores of the plurality of historical data points; and
generating a heat map visualization of the plurality of topic temperatures over time, wherein the heat map visualization is configured to identify a trend or a patterns in the input data stream.

15. The computing system of claim 11, wherein the memory hierarchy includes at least three tiers of memory with different access speeds, and pre-loading the selected one or more AI models further comprises:
distributing the selected one or more AI models across the at least three tiers of memory based on the respective temperature scores.

16. A non-transitory computer-readable storage medium storing one or more programs configured for execution by one or more processors of a computing system, wherein the computing system includes a memory hierarchy, and the one or more programs comprise instructions for:
obtaining an input data stream including a plurality of historical data points;
analyzing the input data stream to determine a temperature score for each of the plurality of historical data points;
generating temperature scores of expert AI models associated with the input data stream based on the temperature scores of the plurality of historical data points;
predicting a temperature and context of a next prompt in the input data stream based on the plurality of historical data points;
selecting one or more AI models from the expert AI models based on the temperature scores of the expert AI models and the temperature and context of the next prompt; and
pre-loading the selected one or more AI models into the memory hierarchy for processing the next prompt.

17. The non-transitory computer-readable storage medium of claim 16, wherein a prediction algorithm is used to predict the temperature and context of the next prompt, the one or more programs further comprising instructions for:
determining an accuracy level of a reply provided by the selected one or more AI models in response to the next prompt; and
refining a prediction algorithm based on the accuracy level of the reply to the next prompt.

18. The non-transitory computer-readable storage medium of claim 16, wherein selecting the one or more AI models further comprises:
implementing a caching mechanism for frequently used model components, wherein the frequently used model components correspond to a plurality of expert domains, and are partially loaded to improve a response time to hybrid queries spanning the plurality of expert domains.

19. The non-transitory computer-readable storage medium of claim 16, wherein the input data stream is obtained for an AI application, and a processing speed and an accuracy level of the AI application are controlled in response to selection and pre-loading of the selected one or more AI models based on the temperature score of each of the plurality of historical data points and the temperature and context of the next prompt.

20. The non-transitory computer-readable storage medium of claim 16, the one or more programs further comprising instructions for dynamically allocating computational resources based on the temperature and context of the next prompt.
